(19) United States
(12) Patent Application Publication
(10) Pub. No.: US 2026/0169642 A1
(43) Pub. Date: Jun. 18, 2026

(54) HARDWARE SECURITY MODULES INTEGRATED IN MEMORY DEVICES AND SYSTEMS

(71) Applicant: SK Hynix NAND Product Solutions Corp. (dba Solidigm), Rancho Cordova, CA (US)

(72) Inventors: Wilson YOUNG, Burnaby (CA); Gamil CAIN, El Dorado Hills, CA (US)

(21) Appl. No.: 18/982,736

(22) Filed: Dec. 16, 2024

(51) Int. Cl. G06F 3/06

(52) U.S. Cl. CPC G06F 3/0622; G06F 3/0655; G06F 3/0679

(57) ABSTRACT

This application is directed to memory methods, systems, and devices for managing secure data and implementing secure operations locally. In one aspect, a memory device includes a non-volatile memory, a memory controller, a secure controller, and an integrated memory enclosure. The non-volatile memory includes a secure memory portion and a data memory portion. The secure memory portion stores secure data, and the data memory portion stores user data. The memory controller is coupled to the data memory portion, and configured to receive a data access request and access the user data in response to the data access request. The secure controller is coupled to the secure memory portion, and configured to access the secure data and implement a secure operation on the secure data. The integrated memory enclosure encloses the secure controller, the memory controller, and the non-volatile memory.

### TECHNICAL FIELD

This application relates generally to data storage device including, but not limited to, methods, systems, and devices for configuring memory devices and systems to integrate hardware security modules and implement in-memory secure operations.

### BACKGROUND

A hardware security module (HSM) is a dedicated physical device that securely manages and protects cryptographic keys, enabling encryption and decryption processes within a controlled environment. The HSM is often implemented using a dedicated security server or discrete form factor (e.g. PCIe card) that provides enhanced security for sensitive data, particularly in sectors such as finance and cloud computing. However, there are notable disadvantages associated with their deployment. First, the requirement for a dedicated appliance necessitates the allocation of specialized space within a computing environment, leading to increased operational and capital expenditures. Second, while HSMs are fully equipped computing platforms, their functionality is often limited to cryptographic operations, which may result in underutilization of computing resources. In scenarios where the use of an HSM is sporadic or infrequent, organizations may find themselves investing in expensive infrastructure that is not consistently leveraged, ultimately diminishing the return on investment.

### SUMMARY

Various embodiments of this application are directed to methods, memory systems, and memory devices for providing a hardware security module locally in a memory device (e.g., a solid-state drive (SSD)). The memory device may integrate security features (e.g., Opal and Attestation, overprovisioning), computational storage functions, and additional hardware tampering detection capabilities, thereby enabling the hardware security module. The hardware security module may implement identity-based authentication, have a physical enclosure, and provide a tamper detection response (e.g., zeroization). In some embodiments, a secure memory portion and a secure controller are created within the memory device to store secure data and implement secure operations on the secure data. For example, the secure data include one or more of: a cryptographic key, a digital certificate, authentication token or data, security policy, and audit log. The secure operation includes one or more of: key generation, encryption, decryption, generation of a digital signature, key wrapping or unwrapping, key storage, key rotation, key destruction, cryptographic hashing, managing a message authentication code (MAC), managing a digital certificate, user authentication and authorization, secure boot, and recording a log. As such, individual memory devices are configured to implement functions of hardware security modules in addition to generic storage functions (e.g., memory access functions, reading and writing of data to non-volatile memory, internal memory management functions) and computational storage functions, thereby offering a streamlined form factor for the hardware security modules with both operational and financial cost benefits.

In some embodiments, a controller of a memory device (e.g., an SSD) is configured to manage data storage, data retrieval, and interfacing with a host. A memory device (also called a storage device) includes a plurality of processing cores, and is transformed to a computational storage device (CSD) by providing both a memory controller and a data processor using the plurality of processing cores. The data processor is configured to process internal computational storage operations (e.g., data processing operations) locally on the memory device, and the memory controller of the memory device is configured to perform generic storage functions including memory access functions (e.g., input/output (I/O) access operations) and internal memory management functions. Further, in some embodiments, the internal computational storage operations of the memory device are customized based on a number and types of companion compute components included in the memory device.

In one aspect, a memory device includes a non-volatile memory, a memory controller, a secure controller, and an integrated memory enclosure. The non-volatile memory includes a secure memory portion and a data memory portion. The secure memory portion stores secure data, and the data memory portion stores user data. The memory controller is coupled to the data memory portion, and configured to receive a data access request and access the user data in response to the data access request. The secure controller is coupled to the secure memory portion, and configured to access the secure data and implement a secure operation on the secure data. The integrated memory enclosure encloses the secure controller, the memory controller, and the non-volatile memory. In some embodiments, the secure memory portion is accessible to the secure controller, and not accessible to the memory controller.

In some embodiments, the secure operation includes one or more of: establishing or managing an administrator credential, associating an administrator account with a set of cryptographic keys, managing one or more administrator privileges for the administrator account, establishing or enforcing one or more policies associated with tampering events for the administrator account, controlling an access to a user account, managing one or more cryptographic keys for a user account, and enabling the administrator account to use the cryptographic key(s) for cryptographic operations.

In some embodiments, the secure data stored in the secure memory portion include a public key. The secure controller is configured to receive a signed message and a signature from a host device coupled to the memory device or from a data processor of the memory device, obtain the public key from the secure memory portion, verify the signature associated with the signed message using the public key, and extract content of the signed message in accordance with verification of the signature.

In another aspect, some implementations include an electronic system that further includes a host device and a memory device of any of the above embodiments. The memory device is coupled to the host device.

In yet another aspect, a computer system includes a plurality of memory devices each of which is implemented as any of the above embodiments. Secure memory portions of the plurality of memory devices provide a distributed hardware security system. By these means, a data center including the computer system may fulfill secure operations locally within individual memory devices and does not need to rely on a dedicated hardware security server. This helps save server real estate on a server rack and conserve data bandwidths for communicating data into and out of the dedicated hardware security server.

These illustrative embodiments and implementations are mentioned not to limit or define the disclosure, but to provide examples to aid understanding thereof. Additional embodiments are discussed in the Detailed Description, and further description is provided there.

### BRIEF DESCRIPTION OF THE DRAWINGS

For a better understanding of the various described implementations, reference should be made to the Detailed Description below, in conjunction with the following drawings in which like reference numerals refer to corresponding parts throughout the figures.

FIG. 1 is a block diagram of an example system module in a typical electronic device in accordance with some embodiments.

FIG. 2 is a block diagram of a storage system of an example electronic device having one or more memory access queues, in accordance with some embodiments.

FIG. 3 is a block diagram of an example computer system that includes a storage system having an internal processing capability, in accordance with some embodiments.

FIG. 4 is a block diagram of an example computer system including a storage system that operates in compliance with a storage access and transport protocol, in accordance with some embodiments.

FIG. 5 is a block diagram of an example memory device including a secure controller locally for implementing an integrated hardware security module locally, in accordance with some embodiments.

FIG. 6 is a block diagram of another example memory device including a secure controller associated with an integrated HSM, in accordance with some embodiments.

FIG. 7 is a block diagram of an example computer system having a distributed hardware security system, in accordance with some embodiments.

Like reference numerals refer to corresponding parts throughout the several views of the drawings.

### DETAILED DESCRIPTION

Reference will now be made in detail to specific embodiments, examples of which are illustrated in the accompanying drawings. In the following detailed description, numerous non-limiting specific details are set forth in order to assist in understanding the subject matter presented herein. But it will be apparent to one of ordinary skill in the art that various alternatives may be used without departing from the scope of claims and the subject matter may be practiced without these specific details. For example, it will be apparent to one of ordinary skill in the art that the subject matter presented herein can be implemented on many types of electronic devices with storage capabilities.

Memory is applied in a computer system to store instructions and data. The data are processed by one or more processors of the computer system according to the instructions stored in the memory. Multiple memory units are used in different portions of the computer system to serve different functions. Specifically, the computer system includes non-volatile memory that acts as secondary memory to keep data stored thereon if the computer system is decoupled from a power source. Examples of the secondary memory include, but are not limited to, hard disk drives (HDDs) and solid-state drives (SSDs). The secondary memory relies on a memory controller to manage its memory space and process read, write, and read-modify-write requests from a host device efficiently with low latency. In some embodiments, a memory device (also called a storage device) includes a plurality of processing cores, and is transformed to a computational storage device (CSD) by configuring two subsets of processing cores to a memory controller and a data processor, respectively. The data processor is configured to process internal computational storage operations (e.g., data processing operations) locally on the memory device, while the memory controller of the memory device specializes in performing generic storage functions including memory access functions (e.g., input/output (I/O) access operations) and internal memory management functions.

Some embodiments of this application are directed to methods, memory systems, and memory devices for providing a hardware security module locally in a memory device (e.g., an SSD). A plurality of processing cores of the memory device may be configured to provide at least a secure controller in addition to a memory controller and a data processor (if any), and a secure data portion is reserved in a non-volatile memory for storing secure data. The memory device may integrate security features, computational storage functions, and hardware tampering detection capabilities to enable a hardware security module within the memory device. Individual memory devices are configured to implement distributed in-memory functions of hardware security modules in addition to generic storage functions (e.g., memory access functions, internal memory management functions) and computational storage functions, thereby offering a streamlined form factor for the hardware security modules with both operational and financial cost benefits. Particularly, in some embodiments, a data center applies the memory devices having distributed hardware security modules, and may fulfill secure operations locally within individual memory devices without relying on a dedicated hardware security server. This helps save server real estate on a server rack and conserve data bandwidths for communicating data into and out of the dedicated hardware security server.

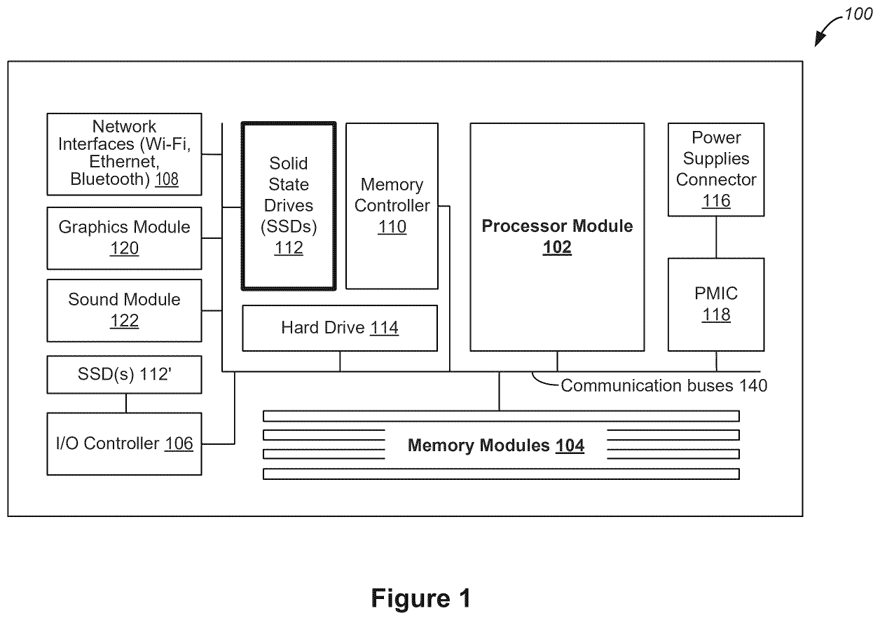

FIG. 1 is a block diagram of an example system module 100 in a typical electronic system in accordance with some embodiments. The system module 100 in this electronic system includes at least a processor module 102, memory modules 104 for storing programs, instructions and data, an input/output (I/O) controller 106, one or more communication interfaces such as network interfaces 108, and one or more communication buses 140 for interconnecting these components. In some embodiments, the I/O controller 106 allows the processor module 102 to communicate with an I/O device (e.g., a keyboard, a mouse or a trackpad) via a universal serial bus interface. In some embodiments, the network interfaces 108 includes one or more interfaces for Wi-Fi, Ethernet and Bluetooth networks, each allowing the electronic system to exchange data with an external source, e.g., a server or another electronic system. In some embodiments, the communication buses 140 include circuitry (sometimes called a chipset) that interconnects and controls communications among various system components included in system module 100.

In some embodiments, the memory modules 104 include high-speed random-access memory, such as static random-access memory (SRAM), double data rate (DDR) dynamic random-access memory (DRAM), or other random-access solid state memory devices. In some embodiments, the memory modules 104 include non-volatile memory, such as one or more magnetic disk storage devices, optical disk storage devices, flash storage devices, or other non-volatile solid state storage devices. In some embodiments, the memory modules 104, or alternatively the non-volatile storage device(s) within the memory modules 104, include a non-transitory computer readable storage medium. In some embodiments, memory slots are reserved on the system module 100 for receiving the memory modules 104. Once inserted into the memory slots, the memory modules 104 are integrated into the system module 100.

In some embodiments, the system module 100 further includes one or more components selected from a storage controller 110, SSD(s) 112, an HDD 114, power management integrated circuit (PMIC) 118, a graphics module 120, and a sound module 122. The storage controller 110 is configured to control communication between the processor module 102 and memory components, including the memory modules 104, in the electronic system. The SSD(s) 112 are configured to apply integrated circuit assemblies to store data in the electronic system, and in many embodiments, are based on NAND or NOR memory configurations. The HDD 114 is a conventional data storage device used for storing and retrieving digital information based on electromechanical magnetic disks. The power supply connector 116 is electrically coupled to receive an external power supply. The PMIC 118 is configured to modulate the received external power supply to other desired DC voltage levels, e.g., 5V, 3.3V or 1.8V, as required by various components or circuits (e.g., the processor module 102) within the electronic system. The graphics module 120 is configured to generate a feed of output images to one or more display devices according to their desirable image/video formats. The sound module 122 is configured to facilitate the input and output of audio signals to and from the electronic system under control of computer programs.

Alternatively or additionally, in some embodiments, the system module 100 further includes SSD(s) 112′ coupled to the I/O controller 106 directly. Conversely, the SSDs 112 are coupled to the communication buses 140. In an example, the communication buses 140 operates in compliance with Peripheral Component Interconnect Express (PCIe or PCIE), which is a serial expansion bus standard for interconnecting the processor module 102 to, and controlling, one or more peripheral devices and various system components including components 110-122.

Further, one skilled in the art knows that other non-transitory computer readable storage media can be used, as new data storage technologies are developed for storing information in the non-transitory computer readable storage media in the memory modules 104, SSD(s) 112 or 112′, and HDD 114. These new non-transitory computer readable storage media include, but are not limited to, those manufactured from biological materials, nanowires, carbon nanotubes and individual molecules, even though the respective data storage technologies are currently under development and yet to be commercialized.

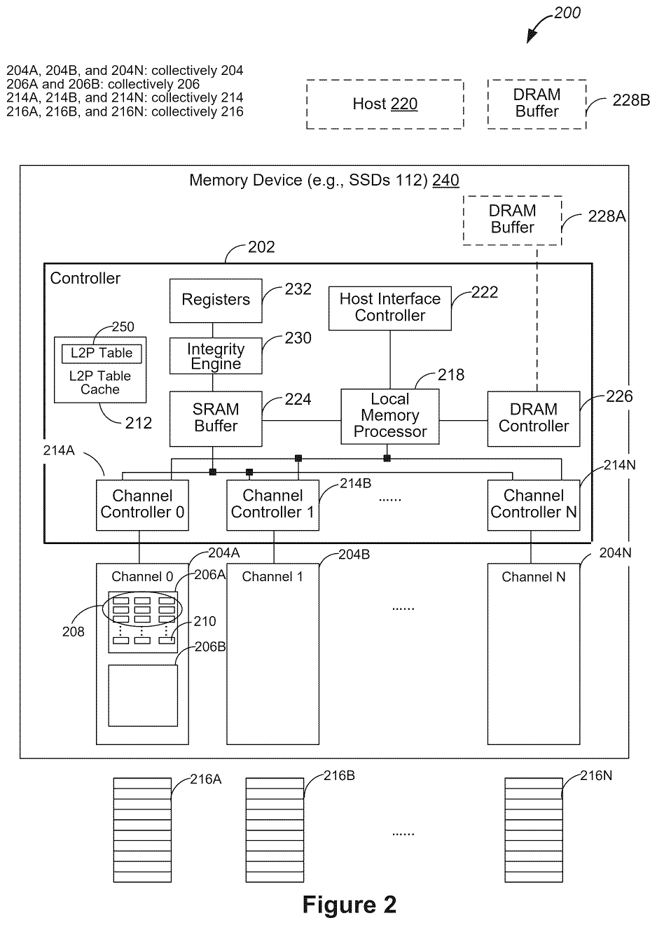

FIG. 2 is a block diagram of a storage system 200 of an example electronic device having one or more memory access queues, in accordance with some embodiments. The storage system 200 is coupled to a host device 220 (e.g., a processor module 102 in FIG. 1) and configured to store instructions and data for an extended time, e.g., when the electronic device sleeps, hibernates, or is shut down. The host device 220 is configured to access the instructions and data stored in the storage system 200 and process the instructions and data to run an operating system (OS) and execute user applications. The storage system 200 includes one or more storage devices 240 (e.g., SSD(s)). Each storage device 240 further includes a controller 202 and a plurality of memory channels 204 (e.g., channel 204A, 204B, and 204N). Each memory channel 204 includes a plurality of memory cells. The controller 202 is configured to execute firmware level software to bridge the plurality of memory channels 204 to the host device 220. In some embodiments, each storage device 240 is formed on a printed circuit board (PCB).

Each memory channel 204 includes one or more memory packages 206 (e.g., two memory dies). In an example, each memory package 206 (e.g., memory package 206A or 206B) corresponds to a memory die. Each memory package 206 includes a plurality of memory planes 208, and each memory plane 208 further includes a plurality of memory pages 210. Each memory page 210 includes an ordered set of memory cells, and each memory cell is identified by a respective physical address. In some embodiments, the storage device 240 includes a plurality of superblocks. Each superblock includes a plurality of memory blocks each of which further includes a plurality of memory pages 210. For each superblock, the plurality of memory blocks are configured to be written into and read from the storage system via a memory input/output (I/O) interface concurrently. Optionally, each superblock groups memory cells that are distributed on a plurality of memory planes 208, a plurality of memory channels 204, and a plurality of memory dies 206. In an example, each superblock includes at least one set of memory pages, where each page is distributed on a distinct one of the plurality of memory dies 206, has the same die, plane, block, and page designations, and is accessed via a distinct channel of the distinct memory die 206. In another example, each superblock includes at least one set of memory blocks, where each memory block is distributed on a distinct one of the plurality of memory dies 206 includes a plurality of pages, has the same die, plane, and block designations, and is accessed via a distinct channel of the distinct memory die 206. The storage device 240 stores information of an ordered list of superblocks in a cache of the storage device 240. In some embodiments, the cache is managed by a host driver of the host device 220, and called a host managed cache (HMC).

In some embodiments, the storage device 240 includes a single-level cell (SLC) NAND flash memory chip, and each memory cell stores a single data bit. In some embodiments, the storage device 240 includes a multi-level cell (MLC) NAND flash memory chip, and each memory cell of the MLC NAND flash memory chip stores 2 data bits. In an example, each memory cell of a triple-level cell (TLC) NAND flash memory chip stores 3 data bits. In another example, each memory cell of a quad-level cell (QLC) NAND flash memory chip stores 4 data bits. In yet another example, each memory cell of a penta-level cell (PLC) NAND flash memory chip stores 5 data bits. In some embodiments, each memory cell can store any suitable number of data bits (e.g., X data bits, where X is greater than 5). Compared with the non-SLC NAND flash memory chips (e.g., MLC SSD, TLC SSD, QLC SSD, PLC SSD), the SSD that has SLC NAND flash memory chips operates with a higher speed, a higher reliability, and a longer lifespan, and however, has a lower device density and a higher price.

Each memory channel 204 is coupled to a respective channel controller 214 (e.g., controller 214A, 214B, or 214N) configured to control internal and external requests to access memory cells in the respective memory channel 204. In some embodiments, each memory package 206 (e.g., each memory die) corresponds to a respective queue 216 (e.g., queue 216A, 216B, or 216N) of memory access requests. In some embodiments, each memory channel 204 corresponds to a respective queue 216 of memory access requests. Further, in some embodiments, each memory channel 204 corresponds to a distinct and different queue 216 of memory access requests. In some embodiments, a subset (less than all) of the plurality of memory channels 204 corresponds to a distinct queue 216 of memory access requests. In some embodiments, all of the plurality of memory channels 204 of the storage device 240 corresponds to a single queue 216 of memory access requests. Each memory access request is optionally received internally from the storage device 240 to manage the respective memory channel 204 or externally from the host device 220 to write or read data stored in the respective channel 204. Specifically, each memory access request includes one of: a system write request that is received from the storage device 240 to write to the respective memory channel 204, a system read request that is received from the storage device 240 to read from the respective memory channel 204, a host write request that originates from the host device 220 to write to the respective memory channel 204, and a host read request that is received from the host device 220 to read from the respective memory channel 204. It is noted that system read requests (also called background read requests or non-host read requests) and system write requests are dispatched by a storage controller 202 to implement internal memory management functions including, but are not limited to, garbage collection, wear levelling, read disturb mitigation, memory snapshot capturing, memory mirroring, caching, and memory sparing. In some embodiments, each of a host write request and a host read request corresponds to a respective input/output (I/O) access operation. Alternatively, in some embodiments, each of a system read request, a system write request, a host write request, and a host read request corresponds to a respective input/output (I/O) access operation

In some embodiments, in addition to the channel controllers 214, the controller 202 further includes a local memory processor 218, a host interface controller 222, an SRAM buffer 224, and a DRAM controller 226. The local memory processor 218 accesses the plurality of memory channels 204 based on the one or more queues 216 of memory access requests. In some embodiments, the local memory processor 218 writes into and read from the plurality of memory channels 204 on a memory block basis. Data of one or more memory blocks are written into, or read from, the plurality of channels jointly. No data in the same memory block is written concurrently via more than one operation. Each memory block optionally corresponds to one or more memory pages. In an example, each memory block to be written or read jointly in the plurality of memory channels 204 has a size of 16 KB (e.g., one memory page). In another example, each memory block to be written or read jointly in the plurality of memory channels 204 has a size of 64 KB (e.g., four memory pages). In some embodiments, each page has 16 KB user data and 2 KB metadata. In some embodiments, each page has user data of a data size that is distinct from 4 KB and 16 KB, and metadata having a data size that is distinct from 2 KB. Additionally, a number of memory blocks to be accessed jointly and a size of each memory block are configurable for each of the system read, host read, system write, and host write operations.

In some embodiments, the local memory processor 218 stores data to be written into, or read from, each memory block in the plurality of memory channels 204 in an SRAM buffer 224 of the controller 202. Alternatively, in some embodiments, the local memory processor 218 stores data to be written into, or read from, each memory block in the plurality of memory channels 204 in a DRAM buffer 228A that is included in storage device 240, e.g., by way of the DRAM controller 226. Alternatively, in some embodiments, the local memory processor 218 stores data to be written into, or read from, each memory block in the plurality of memory channels 204 in a DRAM buffer 228B that is main memory used by the processor module 102 (FIG. 1). The local memory processor 218 of the controller 202 accesses the DRAM buffer 228B via the host interface controller 222.

In some embodiments, data in the plurality of memory channels 204 is grouped into coding blocks, and each coding block is called a codeword. For example, each codeword includes n bits among which k bits correspond to user data and (n-k) corresponds to integrity data of the user data, where k and n are positive integers. In some embodiments, the storage device 240 includes an integrity engine 230 (e.g., an LDPC engine) and registers 232, which include a plurality of registers or SRAM cells or flip-flops and are coupled to the integrity engine 230. The integrity engine 230 is coupled to the memory channels 204 via the channel controllers 214 and SRAM buffer 224. Specifically, in some embodiments, the integrity engine 230 has data path connections to the SRAM buffer 224, which is further connected to the channel controllers 214 via data paths that are controlled by the local memory processor 218. The integrity engine 230 is configured to verify data integrity and correct bit errors for each coding block of the memory channels 204.

In some embodiments, the storage system 200 includes an SSD having an L2P address indirection table 250 that stores physical addresses for a set of logical addresses, e.g., a logical block address (LBA). In some embodiments, the L2P address indirection table 250 is stored in an L2P table cache 212 included in the controller 202. Alternatively, in some embodiments, the storage system 200 includes a DRAM buffer 228A, and the L2P address indirection table 250 is stored in the DRAM buffer 228A. The local memory processor 218 of the controller 202 accesses the DRAM buffer 228A via a DRAM controller 226.

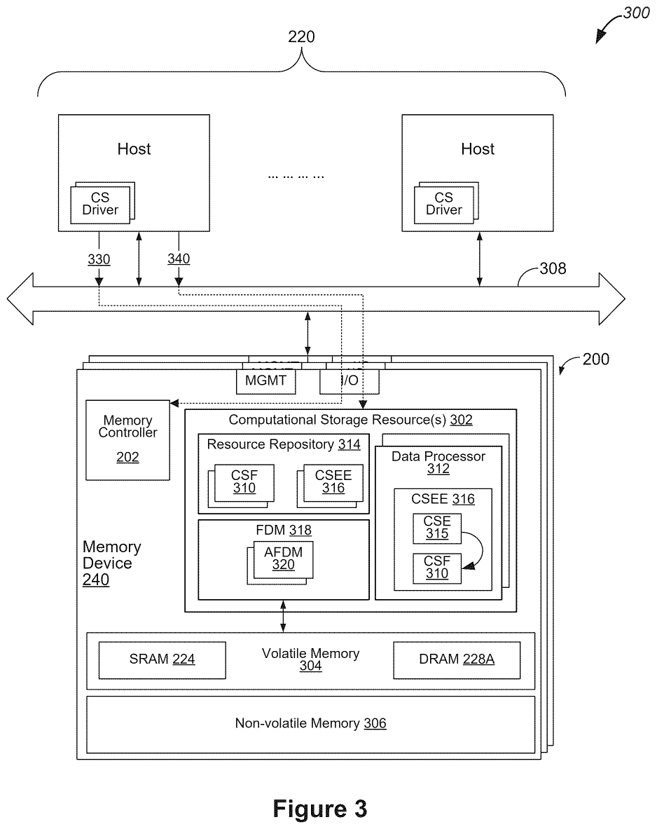

In some embodiments, a memory device 240 (also called a storage device) includes a plurality of processing cores, and is transformed to a computational storage device (CSD) by activating a computational storage configuring two separate subsets of processing cores to a memory controller 202 and a data processor (e.g., data processor 312 in FIG. 3), respectively. The data processor is configured to process internal computational storage operations (e.g., data processing operations) locally on the memory device 240, while the memory controller 202 of the memory device 240 specializes in performing generic storage functions including memory access functions (e.g., input/output (I/O) access operations) and internal memory management functions. In some embodiments, the memory controller 202 and the data processor of the memory device 240 at least partially share certain hardware resources in a time-multiplexed manner. The memory device 240 may operate in a computational storage elevation (CSE) mode, when the hardware resources (e.g., processing cores) are allocated to the computational storage functions or adjusted between the memory access functions and the computational storage functions.

FIG. 3 is a block diagram of an example computer system 300 that includes a storage system 200 having an internal processing capability, in accordance with some embodiments. The storage system 200 is also called a computational storage device (CSD), and includes one or more storage devices 240 (e.g., SSDs). Each storage device 240 further includes a storage controller 202, a volatile memory 304, and a non-volatile memory 306 (e.g., memory channels 204). The host device(s) 220 and the one or more storage devices 240 of the storage system 200 are coupled to each other via a communication fabric 308. The communication fabric 308 includes a communication bus 140 (FIG. 1) that operates in compliance with a data bus standard, e.g., Peripheral Component Interconnect Express (PCIe), Ethernet standards. The host device(s) 220 are configured to issue memory access requests to write data into, and read data from, the non-volatile memory 306. The storage controller 202 accesses the non-volatile memory 306 in response to the memory access operations. Additionally, in some embodiments, the storage controller 202 dispatch system read requests (also called background read requests or non-host read requests) and system write requests to implement internal memory management functions including, but are not limited to, garbage collection, wear levelling, read disturb mitigation, memory snapshot capturing, memory mirroring, caching, and memory sparing. The volatile memory 304 of each storage device 240 further includes one or more of a L2P table cache 212, an SRAM buffer 224, and a DRAM buffer 228A, and is configured to store data temporarily while the storage controller 202 accesses the non-volatile memory 306 for memory accesses or internal memory management.

In some embodiments, the storage controller 202 is dedicated to processing the memory access requests and internal memory management functions. A storage device 240 further includes one or more computational storage resources (CSRs) 302 configured to implement data processing operations locally on the storage device 240. A set of predefined data processing operations are implemented to perform a computational storage function (CSF) 310, which is distinct from the memory access and internal memory management functions performed by the storage controller 202. In some embodiments, a computational storage resource 302 processes user data that are received from the host device(s) 220 or extracted from the non-volatile memory 306 during the data processing operations. In some embodiments, the processed data are stored into the non-volatile memory 306 or sent to the host device(s) 220 via the fabric 308. Further, in some embodiments, a subset of the user data, the process data, and intermediate data generated during the data processing operations is temporarily stored in the volatile memory 304 (e.g., SRAM buffer 224, DRAM buffer 228A).

In some embodiments, the computational storage resource 302 includes one or more data processors 312 and a resource repository 314. The one or more data processors 312 provide a computational storage engine configured to perform one or more predefined data processing operations, e.g., associated with a computational storage function 310 of the computational storage resource 302. In some embodiments, the computational storage function 310 corresponds to an in-memory application associated with the computational storage engine, and is implemented via the computational storage engine in the storage device 240. The resource repository 314 is a centralized location (e.g., memory space) storing various types of data and resources, such as software libraries, configuration files, media files, or any other type of data needed for a plurality of computational storage functions 310 performed by the computational storage resource 302. For example, the resource repository 314 stores instructions for creating a computational storage engine environment (CSEE) 316 and instructions for implementing a set of data processing operations associated with a computational storage function 310 in the CSEE 316. Instructions are loaded from the resource repository 314 and executed by the data processor 312, thereby creating the CSEE 316 where the computational storage engine 315 is executed to implement data processing operations associated with the computational storage function 310.

In some embodiments, the computational storage resource 302 further includes a function data memory (FDM) 318 for storing data that are used or generated by the computational storage engine 315 for performing a computational storage function 310. In some embodiments, the function data memory 318 is included in the volatile memory 304. For example, the function data memory 318 corresponds to a portion of the DRAM buffer 228A (FIG. 2). In another example, the function data memory 318 corresponds to a portion of the SRAM buffer 224 (FIG. 2). Further, in some embodiments, a portion of the function data memory 318 (also called an allocated FDM (AFDM) 320) is allocated for one or more instances of a computational storage function 310.

In some embodiments, a host device 22 issues a memory read or write request 330 to a storage device 240 of the storage system 200, and the storage controller 202 of the storage device 240 receives the memory read or write request 330 and accesses the non-volatile memory 306 accordingly. Alternatively, in some embodiments, a host device 22 issues a data processing request 340 to the storage device 240, and a data processor 312 of the computational storage resource 302 (e.g., the computational storage engine 315) receives the data processing request 340 and processes user data extracted from the data processing request or the non-volatile memory 306.

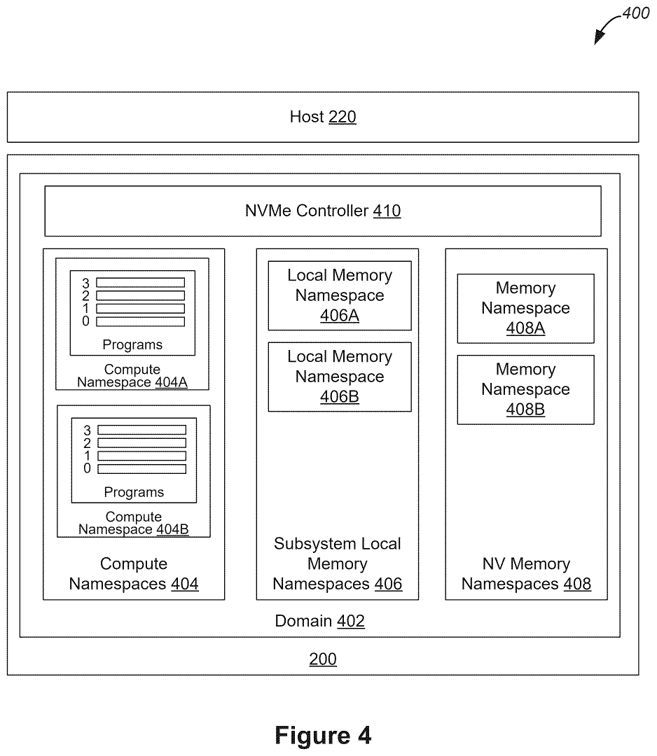

FIG. 4 is a block diagram of an example computer system 400 including a storage system 200 that operates in compliance with a storage access and transport protocol (e.g., nonvolatile memory express (NVMe)), in accordance with some embodiments. The storage system 200 includes one or more storage devices 240 each of which corresponds to a domain 402 according to the storage access and transport protocol. Each domain 402 corresponding to a respective storage device 240 includes a one or more compute namespace 404, local memory namespaces 406, memory namespaces 408, and a domain controller 410. Each namespace is a collection of LBAs accessible to, or associated with, a respective one of the plurality of programs.

A storage device 240 includes one or more processors having a computation capability (e.g., a storage controller 202, a data processor 312), a volatile memory 304 (e.g., a cache 212, an SRAM buffer 224, a DRAM buffer 228A), and a non-volatile memory 306. When the storage device 240 executes a plurality of programs, resources of the storage controller 202, the volatile memory 304, and the non-volatile memory 306 are allocated to implement the plurality of programs based on the storage access and transport protocol (e.g., NVMe). A plurality of compute namespaces 404 (e.g., 404A and 404B) correspond to, are configured to provide, instructions of the plurality of programs executed by the one or more programs of the storage device 240. Resources of the volatile memory 304 are allocated based on a plurality of local memory namespaces 406 (e.g., 406A and 406B) to facilitate execution of the plurality of programs by the storage device 240, so are resources of the non-volatile memory 306 allocated based on a plurality of memory namespaces 408 (e.g., 408A and 408B). It is noted that, in some embodiments, the number of programs is not limited to 2 and may be greater than 2, thereby creating more than two namespaces in each type of compute namespaces 404, 406, or 408.

In an example, a compute namespace 404A corresponds to a respective local memory namespace 406A and a respective non-volatile memory namespace 408A. The compute namespace 404A provides instructions of a corresponding program for execution by the one or more processors of the storage device 240. In some situations, input data that are processed, and output data that are generated, by these instructions are temporarily stored based on the local memory namespace 406A. In some situations, the input data are extracted based on the non-volatile memory namespace 408A, and the output data are stored based on the non-volatile memory namespace 408A. By these means, namespace allocation and utilization in the domain 402 corresponding to the storage device 240 are managed according to the storage access and transport protocol.

In some embodiments, the storage access and transport protocol includes a NVMe protocol for accessing flash storage (e.g., SSDs) via a PCI Express (PCIe) bus. The PCIe bus is configured to support a plurality of parallel command queues (e.g., on an order of 104 queues), thereby operating with a substantially high throughput and a substantially fast response time. In some embodiments, the host device 220 is configured to communicate and interact with each storage device 240 (e.g., SSD) as a standard NVMe storage device using the NVMe protocol. The host device 220 is configured to read and write data and implement data processing operations on the storage device 240 using NVMe commands.

In some embodiments, the host device 220 uses an operating system (e.g., a Linux operating system), and the CSRs 302 (FIG. 3) of the storage device 240 uses an embedded operating system (e.g., an embedded Linux operating system) that matches the operating system of the host device 220. In some embodiments, the host device 220 uses extended vendor unique commands to control and interact with the embedded operating system of the CSRs 302 of the storage device 240.

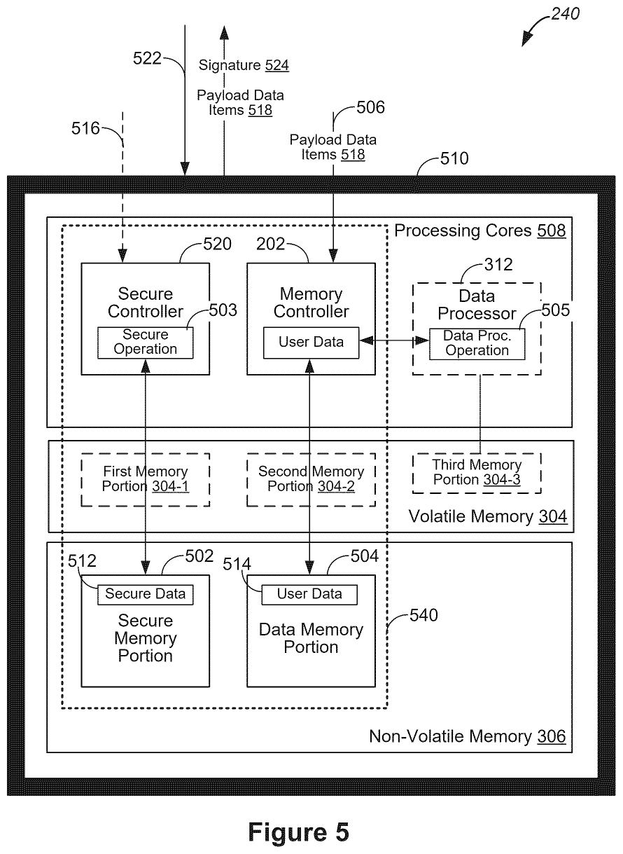

FIG. 5 is a block diagram of an example memory device 240 including a secure controller 520 for implementing an integrated hardware security module (HSM) 540, in accordance with some embodiments. The memory device 240 includes a non-volatile memory 306, a memory controller 202, the secure controller 520, and an integrated memory enclosure 510 enclosing the secure controller 520, the memory controller 202, and the non-volatile memory 306. The non-volatile memory 306 has a secure memory portion 502 for storing secure data 512 (e.g., in an encrypted format) and a data memory portion 504 for storing user data 514. The memory controller 202 is coupled to the data memory portion 504, and configured to receive a data access request 506 (e.g., from a host device 220) and access the user data 514 in response to the data access request 506. In other words, the memory controller 202 is applied to perform generic storage functions including memory access functions (e.g., input/output (I/O) access operations) and internal memory management functions associated with the non-volatile memory 306. The secure controller 520 is coupled to the secure memory portion 502, and configured to access the secure data 512 and implement a secure operation 503 on the secure data 512 (e.g., which may be encrypted). In an example, the secure data 512 include an encrypted format of plaintext cryptographic security parameters (CSPs), and the secure controller 520 is configured to operate on the plaintext CSPs.

In some embodiments, a portion of the memory device 240 corresponds to the integrated HSM 540 that is separated and reserved for the secure operation 503 and the secure data 512. The secure data 512 is stored in the secure memory portion 502, and the secure operation 503 is implemented by a dedicated secure controller 520. In some embodiments, the secure memory portion 502 and the secure controller 520 are measured based on a number of keys that can be generated and managed on the memory device 240. The memory controller 202 is prohibited from accessing the secure memory portion 502 or implementing any secure operation 503. In some embodiments, a size of the secure controller 520 is determined based on a number of secure operations 503 that need to be implemented for this memory device 240, and a size of the secure memory portion 502 is determined based on a size of the secure data 512 associated with the memory device 240. Further, in some embodiments, the size of the secure controller 520, the size of the secure memory portion 502, or both may be dynamically adjusted in response to a demand on secure operations 503 and secure data 512. By these means, the in-memory hardware security module (HSM) 540 is created locally within the memory device 240, and the memory device 240 does not need to access another dedicated HSM device distinct from the memory device 240 (e.g., via a communication network) for storing the secure data 512 or implementing the secure operation 503.

In some embodiments, the memory device 240 (e.g., the memory controller 202) independently performs alternative security operations (e.g., encryption and decryption of the user data 514) on data stored in the data memory portion 504. The alternative security operations performed by the memory device 240 (e.g., the memory controller 202) are separate and unrelated to the HSM functionality of the memory device 240. In other words, inclusion of the HSM functionality by way of the secure controller 520 and the secure memory portion 502 does not necessarily preclude other (non-HSM) security operations to be performed in the memory controller 202 or the data processor 312.

In some embodiments, the memory device 240 further includes a data processor 312, the secure controller 520, and the memory controller 202. The data processor 312 is coupled to the non-volatile memory 306, and configured to exchange the user data 512 with the memory controller 202 and implement a data processing operation 505 associated with the user data 202. In some situations, the data processor 312 extracts the user data 512 from the data memory portion 504 of the non-volatile memory 306 via the memory controller 202, and implements the data processing operation 505 on the extracted user data 512. Alternatively, in some situations, the data processor 312 generates the user data 512 by the data processing operation 505 and stores the user data 512 into the data memory portion 504 of the non-volatile memory 306 via the memory controller 202.

Further, in some embodiments, the data processor 312 is configured to implement the data processing operation 505 associated with the user data 514 based on a result of the secure operation 503 implemented by the secure controller 520 on the secure data 512. For example, the secure controller 520 verifies a user account from which a user request for implementing the data processing operation based on the secure data 512. In accordance with a verification of the user account by the secure controller 520 based on the secure data 512, the user request is approved, and the data processing operation 505 is implemented on the user data 514 by the data processor 312. The memory controller 202 may intervene to orchestrate following secure operation 503 and the data processing operation 505. In some situations, the memory controller 202 interacts with the secure controller 520 to authenticate the user account, and once authenticated, leverages the authentication to provide the user data 514 needed by the data processor 312 for processing. That said, in some embodiments, in accordance with a verification of the user account by the secure controller 520 based on the secure data 512, the memory controller 202 accesses the data memory portion 504 to extract the user data 514 and provides the user data 514 to the data processor 312 for further processing.

In some embodiments, a subset of the secure data 512 is independent of a subset of the user data 514. For example, in some situations, the secure controller 520 receives a host request 516 for a cryptographic key. In response to the host request 516, the secure controller 520 may extract a cryptographic key from the secure memory portion 502 or generate a cryptographic key, e.g., based on a seed extracted from the secure memory portion 502 and without involving any user data 514 stored in the data memory portion 504. In some situations, the host device 220 provides payload data items 518 to be written into the data memory portion 504, independently of any secure data 512.

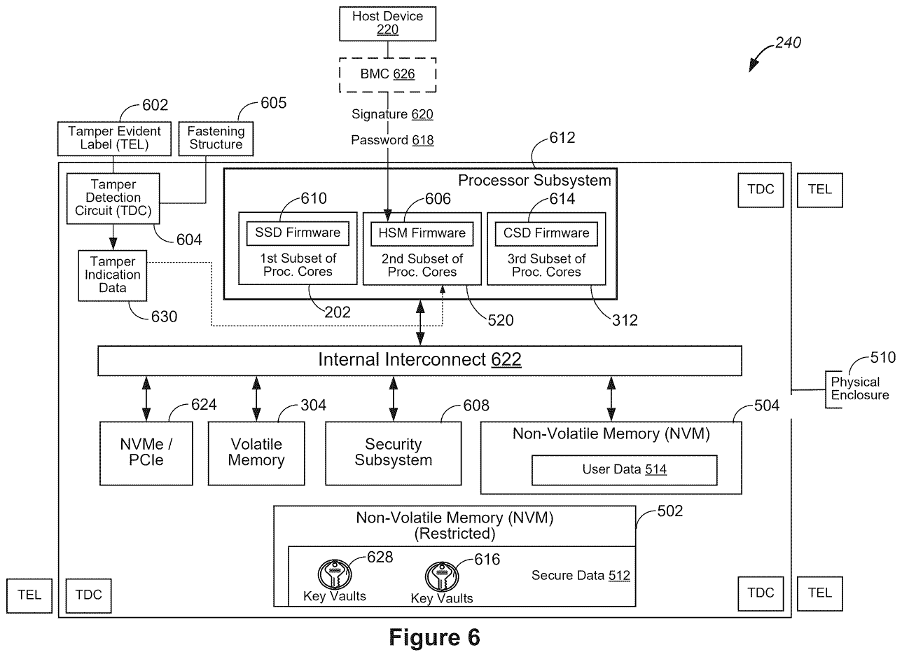

Conversely, in some embodiments, the subset of the secure data 512 and the subset of the user data 514 are associated with each other. In some embodiments, the secure controller 520 is configured to authenticate a user account based on the subset of secure data 512 and generate an authentication confirmation, and the memory controller 202 is configured to grant the access to the subset of user data 514 based on the authentication confirmation. More specifically, in some embodiments, the memory device 240 receives a request 522 for payload data items 518 from the host device 220. In response to the request 522, the memory controller 202 extracts the payload data items 518 from the data memory portion 504, and provides the payload data items 518 to the secure controller 520 (e.g., directly, via the host device 240, or via a buffer 304-1). The secure controller 520 obtains a cryptographic key, generates a digital signature 524 using the cryptographic key (e.g., a private key 628 in FIG. 6) for the payload data items 518, and provides the payload data item 518 jointly with the payload data item 518.

In some embodiments, the memory device 240 includes a plurality of processing cores 508 that are configured to provide two separate subsets of processing cores corresponding to a memory controller 202 and a secure controller 520. Alternatively, in some embodiments, the plurality of processing cores 508 is configured to further provide a third subset of processing cores corresponding to a data processor 312, thereby transforming the memory device 240 to a computational storage device (CSD). The data processor 312 is configured to perform internal computational storage operations (e.g., data processing operations) on the user data 514 locally within the memory device 240, while the memory controller 202 of the memory device 240 specializes in performing storage functions including memory access functions and internal memory management functions. In some embodiments, the memory controller 202 and the data processor 312 of the memory device 240 correspond to separate hardware resources. In some embodiments, the memory controller 202 and the data processor 312 of the memory device 240 at least partially share certain hardware resources in a time-multiplexed manner. For data security, the secure controller 520 corresponds to separate hardware resources including the secure memory portion 502, and does not share any of the hardware resources with the memory controller 202 and the data processor 312.

In some embodiments, the memory device 240 further includes a volatile memory 304 including a first memory portion 304-1 (also called buffer 304-1) and a second memory portion 304-2. The first memory portion 304-1 is coupled to the secure controller 520, and accessible by the secure controller 520 to store the secure data 512 temporarily. The second memory portion 304-2 is coupled to the memory controller 202, and accessible by the memory controller 202 to store the user data 504 temporarily, e.g., in response to the data access request 506. Further, in some embodiments, the volatile memory 304 further includes a third memory portion 304-3 coupled to the data processor 312 for storing data temporarily when the data are accessed or processed by the data processor 312. Additionally, in some embodiments, the secure memory portion 502 is segmented or isolated from a remainder of the non-volatile memory 306 (e.g., the data memory portion 504). For example, the secure memory portion 502 is separated logically and/or physically from the data memory portion 504, e.g., has separate mappings for logical and physical addresses.

FIG. 6 is a block diagram of another example memory device 240 including a secure controller 520 associated with an integrated HSM 540, in accordance with some embodiments. The memory device 240 includes a non-volatile memory 306, a memory controller 202, and the secure controller 520. The non-volatile memory 306 has a secure memory portion 502 for storing secure data 512 and a data memory portion 504 for storing user data 514. The memory controller 202 is coupled to the data memory portion 504, and configured to receive a data access request 506 (e.g., from a host device 220) and access the user data 514 in response to the data access request 506. The secure controller 520 is coupled to the secure memory portion 502, and configured to access the secure data 512 and implement a secure operation 503 on the secure data 512.

In some embodiments, cryptographic keys are stored by the secure memory portion 502 and processed by the secure controller 520, and never leave the secure memory portion 502 and the secure controller 520 in plain text. Operations like encryption, signing, and decryption are performed inside the secure controller 520. Further, the memory device 240 is designed to resist physical and logical attacks. If tampering is detected, the secure controller 520 may delete or zeroize the keys. In some situations, the secure controller 520 may zeroize keys that are stored in the data memory portion 504. Additionally, the memory device 240 is applied with strict compliance with regulations (e.g., PCI-DSS, FIPS 140-2/3, GDPR) to protect the secure data 512.

In some embodiments, the secure data 512 include one or more of: a cryptographic key, a digital certificate, authentication token or data, security policy, and audit log. In other words, in some embodiments, the secure memory portion 502 stores cryptographic data (keys, certificates, tokens) and associated metadata, and does not store user data (confidential or otherwise). The secure controller 520 and the secure memory portion 502 provide cryptographic services, using the cryptographic data the secure controller 520 generates. In an example, an output of the cryptographic services includes security assets (digital signatures, encrypted data, etc.), and is presented to the host device 220. In some embodiments, the host device 220 stores the output of the cryptographic services to the data memory portion 504 of the same memory device 240 or a distinct memory device 240.

In some embodiments, the secure operation 503 implemented by the secure controller 520 includes one or more of: key generation, encryption, decryption, generation of a digital signature, key wrapping or unwrapping, key storage, key rotation, key destruction, cryptographic hashing, managing an MAC, managing a digital certificate, user authentication and authorization, secure boot, and recording a log.

In some embodiments, the memory device 240 integrated with an HSM includes one or more of: one or more tamper evident labels (TELs) 602, a temper detection circuit (TDC) 602, an HSM firmware 606, a security subsystem 608, and a secure memory portion 502 of the non-volatile memory (NVM) 306, in addition to SSD firmware 610. In some embodiments, the integrated memory enclosure 510 includes, or is coupled to, the one or more TELs 602. The one or more TELs 602 are coupled to, or formed on, an external surface the integrated memory enclosure 510, visibly indicating whether a tamper attempt has occurred to the memory device 240. In an example, the integrated memory enclosure 510 includes a single TEL mechanically coupled to an edge or a corner of the memory device 240. In another example, the integrated memory enclosure 510 includes four TELs mechanically coupled to four corners of the memory device 240 using four screws. The four screws are also used to assemble, and hold together, the integrated memory enclosure 510. In some situations, when any of the four screw is unfastened to de-case the integrated memory enclosure 510, a respective TEL is unavoidably damaged, indicating that the integrated memory enclosure 510 is tampered.

In some embodiments, the TDC 604 is configured to provide an electrical signal to a processor subsystem 612, e.g., when the TDC 604 detects physical separation of the integrated memory enclosure 510 (e.g. caused by a removal of an upper and outer shell). The electrical signal indicates whether the integrated memory enclosure 510 is broken or tampered. For instance, the TDC 604 may be coupled with internal sides of the enclosure 510, where the two sides of the enclosure 510 are physically coupled to each other. The TDC 605 is configured to detect separation of the two sides of the enclosure 510, thereby generating the electrical signal monitored by the secure controller 520. In some embodiments, a fastening structure 605 (e.g., a screw) is applied to mechanically hold the integrated memory enclosure 510. The TDC 604 is electrically coupled to the fastening structure 605, and configured to generate tamper indication data 630 indicating an occurrence of a tamper attempt in response to a mechanical unfastening force applied to the fastening structure 605. Additionally, in some embodiments, the secure controller 520 receives the tamper indication data 630 directly from the TDC 604. In response to receiving the tamper indication data 630, the secure controller 520 selects one of a plurality of tamper deterring actions, and the plurality of tamper deterring actions include at least self destruction of the secure memory portion 502 storing the secure data 512. Each tamper deterring action corresponds to a respective action condition or policy. If the tamper indication data 630 satisfies the respective action condition or policy, the respective tamper deterring action is selected and implemented.

In some embodiments, the memory device 240 includes a plurality of processing cores corresponding to the processor subsystem 612. A first subset of processing cores is allocated to a memory controller 202 (e.g., executing the SSD firmware 610), and a second subset of processing cores is allocated to a secure controller 520 (e.g., executing the HSM firmware 606). Each of the first subset of processing cores corresponding to the memory controller 202 is distinct from the second subset of processing cores corresponding to the secure controller 520. In some embodiments, a size of the second subset of processing cores is determined based on a number of secure operations 503 (FIG. 5) that need to be implemented by the secure controller 520 for this memory device 240. By these means, the memory device 240 includes full functionality of an integrated HSM 540 (FIG. 5) and operates as both a storage device (e.g., SSD) and an HSM simultaneously. Further, in some embodiments, the memory device 240 further includes a third subset of processing cores allocated to a data processor 312 (e.g., executing a CSD firmware 614), allowing the memory device 240 to act as a computational storage device having an integrated HSM 540.

Further, in some embodiments, the HSM firmware 606 includes program codes that perform logical functionality of the integrated HSM 540, e.g., a plurality of predefined secure operations. For example, the HSM firmware 606 may create an interface to an end user over a transport interface (e.g. NVMe, PCIe). The HSM firmware 606 may include instructions, when executed by the secure controller 520, causing the secure controller 520 to interact with the security subsystem 608 to execute cryptographic functions and manage logical access controls. In some embodiments, the HSM firmware 606 enables HSM users to perform HSM related tasks, which include, but are not limited to: establishment and management of an administrator credential, associating an administrator account to a respective set of cryptographic keys which the administrator account can manage, enforcing access controls and administrator privileges, allowing an administrator account to establish policies for tampering events and enforcing these policies, enabling an administrator account to manage (e.g., rotate, crypto erase, revoke) cryptographic keys, and enabling an administrator account to use cryptographic keys for cryptographic operations (e.g., signing, encryption).

In some embodiments, the security subsystem 608 is a combination of firmware and hardware that performs cryptographic operations for the integrated HSM 540 of the memory device 240. In other words, the security subsystem 608 includes the secure controller 520 and the secure memory portion 502 of the non-volatile memory 306. In some embodiments, the security subsystem 608 is the only entity in the memory device 240 that is allowed to operate on CSPs and is configured to protect an encrypted format of the CSPs stored in the secure memory portion 502 of the non-volatile memory 306.

In some embodiments, the non-volatile memory 306 is partitioned into a secure memory portion 502 that stores secure data 512 and a data memory portion 504 that stores user data 514. Alternatively, in some embodiments, the secure memory portion 502 and the data memory portion 504 are two distinct non-volatile memories, collectively forming the non-volatile memory 306. The data memory portion 504 is accessible to the memory controller 202, and the user data 514 may be read from, or written into, the data memory portion 504 by the memory controller 202 in response to a data access request 506 received from a host device 220 or a data processor 312. The secure memory portion 502 is a restricted access area that is only available to the security subsystem 608 (e.g., a secure controller 520).

In some embodiments, the secure data 512 are stored as an encrypted format of CSPs in the secure memory portion 512 of the non-volatile memory 502, and the secure controller 520 is configured to operate on the CSPs. The secure controller 520 operates on plaintext CSPs, and when operations are completed, the resulting CSPs are written back to the secure memory portion 502 in an encrypted format within the secure memory portion 512. Additionally, in some embodiments, the non-volatile memory 306 are physically partitioned to the secure memory portion 502 and the data memory portion 504. Secure operations 503 are associated with a plurality of logical addresses, which are mapped to a plurality of physical addresses within the secure memory portion 502 to store the CSPs associated with the secure operations 503. Alternatively, in some embodiments, the non-volatile memory 306 are logically partitioned to the secure memory portion 502 and the data memory portion 504. Secure operations 503 are associated with a plurality of logical addresses within the secure memory portion 502, and the logical addresses are mapped to a plurality of physical addresses of the non-volatile memory 306 to store the CSPs associated with the secure operations 503. Independently of logical or physical partitioning, the secure memory portion 502 is a restricted memory area in the non-volatile memory 306 to which the security subsystem 608 has an exclusive access.

In some embodiments, the secure operation 503 implemented by the secure controller 520 is based on one or more fundamental public key infrastructure (PKI) principles. In an example, the secure operation 503 includes a two-factor authentication implemented based on personal identification information (e.g., administrator password) and an asymmetric private key. The asymmetric private key is applied to generate a signature to authenticate an administrator account over a challenge provided by the memory device 240 having an HSM firmware 606. Stated another way, in some embodiments, the secure controller 520 is configured to verify a first user account (e.g., an administrative account) associated with a host device 220. The secure controller 520 receives, from the host device 220, a password 618 associated with the first user account and a signature 620 provided by the first user account. The signature 620 is previously generated by the host device 220 based on a private key and a challenge, which is provided by the secure controller 520 to the host device 220. The secure controller 520 verifies the password, 618 challenge and the signature 620 (e.g., using a public key 616 corresponding to the host's private key). In accordance with a verification of both the password 618 and the signature 620, the secure controller 520 provides the secure data 512 to the host device 220. More details on authenticating a user account based on both information owned by the host device 220 (e.g., the password 618) and information owned by the host device 220 (e.g., the asymmetric private key of the host device 220) are discussed in U.S. patent application Ser. No. 18/237,345, filed Aug. 23, 2024, titled “Methods and Systems for Enabling Custom Features Using Public Key Infrastructure in Memory Devices,” which is incorporated herein in its entirety.

It is noted that, in some embodiments, this invention can support multiple users accessing the HSM functionality. Each user would have a unique password and signature that is individually verified by the secure controller 520. Each user has a separate set of CSP(s) associated with the user's credentials.

In some embodiments, the secure data 512 stored in the secure memory portion 502 include a public key 616. The secure controller 512 is configured to receive a signed message 620 from a host device 220 coupled to the memory device 240 or from a data processor 312 of the memory device 240, obtain the public key 616 from the secure memory portion 502, verify the signature 620 associated with the signed message using the public key 616, and extract content of the signed message in accordance with verification of the signature 620. Conversely and alternatively, in some embodiments, the secure data 512 stored in the secure memory portion 502 include a private key 628. The secure controller is configured to generate a signature based on the private key 628, generate a signed message based on the user data, 514 and provide the signed message to a host device 220 coupled to the memory device 240 or to a data processor 312 of the memory device 240.

In some embodiments, the memory device 240 further includes an internal interconnect bus 622 to which the processor subsystem 612, volatile memory 304, security subsystem 608, and non-volatile memory 306 (e.g., memories 502 and 504, or memory portions 502 and 504) are coupled. In some embodiments, the internal interconnect bus 622 operates based on a data transport protocol 624, which includes a peripheral component interconnect express (PCIe) protocol and a nonvolatile memory express (NVMe) protocol.

In some embodiments, the secure controller 520 and the secure memory portion 502 are conveniently integrated in the memory device 240 without requiring hardware changes. The memory device 240 is thereby transformed to provide a local signing service without resorting to a remote networked entity. In some embodiments, the memory device 240 is configured to act as a hardware security module (HSM), using cryptography to help securely store essential and critical information to enable authentication for a computer platform. By these means, the memory device 240 may fulfill secure operations 503 locally without relying on a distinct hardware security server, thereby reducing operational costs associated with managing a separate, standalone HSM appliance.

In some embodiments, a memory device 240 and a baseboard management controller (BMC) 626 are embedded in a server's motherboard, and the BMC 626 is a specialized service processor that remotely monitors the physical state of a host device 220, such as a computer, network server, or other hardware devices. The memory device 240 may provide secure operations 503 out of band to the BMC 626. In some embodiments, the memory device 240 may implement a secure operation 503 associated with the host device 220, which is coupled to the memory device 240 via the BMC 626. In some embodiments, the memory device 240 includes, or is coupled to, a BMC 626 via a two-wire serial communication protocol (e.g., I2C), and the BMC 626 is configured to access, via the secure controller 520, the secure data 512 stored in the secure memory portion 502, thereby using HSM services of the secure controller 520. Stated another way, the BMC is configured to apply the secure controller to access the secure data and implement the secure operation on the secure data.

In some embodiments, from a hardware perspective, the memory device 240 implementing secure operations 503 are FIPS 140 Level 3 certified, indicating that the memory device 240 can detect when it has been tampered with and respond to a tampering event (e.g. by destroying keys upon detection of the tampering event). FIPS 140 Level 3 is a certification standard established by the National Institute of Standards and Technology (NIST). This level of certification ensures that the HSM meets stringent security requirements, including implementation of physical tamper resistance and response mechanisms to thwart unauthorized access or modification. The memory device 240 achieving FIPS 140 Level 3 also employs cryptographic key management practices, ensuring that sensitive information is securely generated, stored, and processed. In some embodiments, from a software perspective, the memory device 240 implementing secure operations 503 enables a user (e.g., a host device 220) to establish its identities within the memory device (e.g., by applying identity-based authentication), associate the user with a set of capabilities (e.g. for access control), and create and manage cryptographic keys.

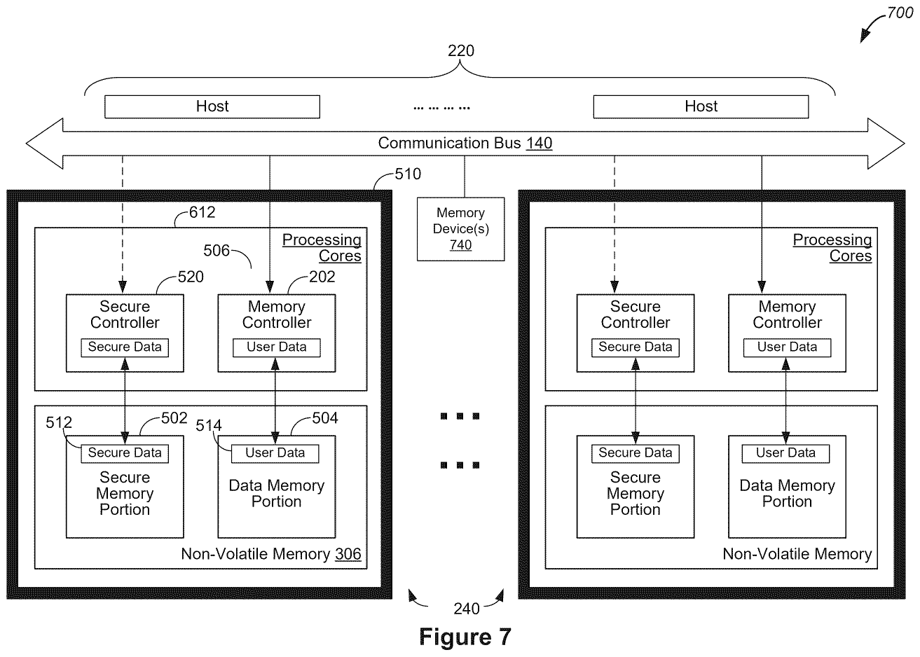

FIG. 7 is a block diagram of an example computer system 700 having a distributed hardware security system, in accordance with some embodiments. The computer system 700 includes a plurality of memory devices 240, and each memory device 240 further includes a non-volatile memory 306, a memory controller 202, and a secure controller 520. The non-volatile memory 306 has a secure memory portion 502 and a data memory portion 504. The secure memory portion 502 stores secure data 512, e.g., in an encrypted format, and the data memory portion 504 stores user data 514. The memory controller 202 is coupled to the data memory portion 504, and configured to receive a data access request 506 (e.g., from a host device 220) and access the user data 514 in response to the data access request 506. The secure controller 520 coupled to the secure memory portion, the secure controller configured to access the secure data and implement a secure operation 503 (FIG. 5) on the secure data. In some embodiments, each memory device 240 includes an integrated memory enclosure 510 for enclosing the secure controller 520, the memory controller 202, and the non-volatile memory 306. Alternatively, in some embodiments, the plurality of memory devices 240 shares an integrated memory enclosure 510 enclosing all of the plurality of memory devices 240.

In some embodiments, the plurality of memory devices 240 are electrically coupled to one another and to one or more host devices 220 via a communication bus 140 (FIG. 1) that operates in compliance with a data bus standard, e.g., PCIe, Ethernet standards. In some embodiments, the secure controller 520 of each memory device 240 is coupled to a host device 220 via a data transport protocol, which includes a peripheral component interconnect express (PCIe) protocol and a nonvolatile memory express (NVMe) protocol.

In some embodiments, a data center includes the computer system 700 and may fulfill secure operations locally within individual memory devices 240 without relying on a dedicated hardware security server. This helps save server real estate for installing the hardware security server on a server rack and conserve data bandwidths for communicating data into and out of the dedicated hardware security server.

In some embodiments, the plurality of memory devices include a first plurality of memory devices 240, and the computer system 700 further includes a second plurality of memory devices 240 distinct from the first plurality of memory devices 240. Each of the second plurality of memory devices 740 does not include a secure controller 520 or a secure memory portion 502. Further, in some embodiments, each of a subset of the second plurality of memory devices 740 is configured to include a secure controller 520 and a secure memory portion 502 dynamically, e.g., based on a demand of the secure data 512. For example, the demand is measured by a number of cryptographic keys stored in the secure memory portion 512. In some embodiments, each of a subset of the first plurality of memory devices 240 is configured to exclude the secure controller 520 and the secure memory portion 502 (e.g., convert the secure controller 520 and the secure memory portion 502 to the memory controller 202 and the data memory portion 504, respectively). Additionally, in some embodiments, a user instruction is received to dynamically configure the subset of the second plurality of memory devices 240 or the subset of the first plurality of memory devices 240. Stated another way, the HSM functionality may be dynamically scaled across the memory devices 240 of the computer system 700.

Additionally, in some embodiments, the first plurality of memory devices 240 having HSM firmware 606 has a first number of memory devices, and the second plurality of memory devices 740 having no HSM firmware 606 has a second number of memory devices. The second number is greater than the first number. In some embodiments, the first number is much smaller than the second number (e.g., smaller by at least one order), such that deployment of the HSM firmware 606 is considered as sporadic and infrequent in the computer system 700.

Various examples of aspects of the disclosure are described as numbered clauses (1, 2, 3, etc.) for convenience. These are provided as examples, and do not limit the subject technology. Identifications of the figures and reference numbers are provided below merely as examples and for illustrative purposes, and the clauses are not limited by those identifications.
Clause 1. A memory device, comprising: a non-volatile memory including a secure memory portion and a data memory portion, wherein the secure memory portion stores secure data, and the data memory portion stores user data; a memory controller coupled to the data memory portion, the memory controller configured to receive a data access request and access the user data in response to the data access request; a secure controller coupled to the secure memory portion, the secure controller configured to access the secure data and implement a secure operation on the secure data; and an integrated memory enclosure for enclosing the secure controller, the memory controller, and the non-volatile memory.
Clause 2. The memory device of clause 1, wherein the secure data is associated with the user data, and the user data is accessed based on a result of the secure operation on the secure data.
Clause 3. The memory device of clause 1 or 2, further comprising: a volatile memory including a first memory portion and a second memory portion; wherein the first memory portion is coupled to the secure controller and is accessible by the secure controller to store the secure data temporarily, and the second memory portion is coupled to the memory controller and accessible by the memory controller to store the user data temporarily in response to the data access request.
Clause 4. The memory device of any of clauses 1-3, further comprising: a data processor coupled to the non-volatile memory, the secure controller, and the memory controller, wherein the data processor is configured to exchange the user data with the memory controller and implement a data processing operation associated with the user data.
Clause 5. The memory device of clause 4, wherein the data processor is configured to implement the data processing operation associated with the user data based on a result of the secure operation implemented by the secure controller on the secure data.
Clause 6. The memory device of any of clauses 1-5, wherein the secure data include one or more of: a cryptographic key, a digital certificate, authentication token or data, security policy, and audit log.
Clause 7. The memory device of any of clauses 1-6, wherein the secure operation includes one or more of: key generation, encryption, decryption, generation of a digital signature, key wrapping or unwrapping, key storage, key rotation, key destruction, cryptographic hashing, managing a message authentication code (MAC), managing a digital certificate, user authentication and authorization, secure boot, and recording a log.
Clause 8. The memory device of any of clauses 1-7, wherein the secure operation includes one or more of: establishing or managing an administrator credential; associating an administrator account with a set of cryptographic keys; managing one or more administrator privileges for the administrator account; establishing or enforcing one or more policies associated with tampering events for the administrator account; controlling an access to a user account; managing a cryptographic key(s) for a user account; and enabling the administrator account to use the cryptographic key(s) for cryptographic operations.
Clause 9. The memory device of any of clauses 1-8, wherein the secure controller is configured to authenticate a user account based on the secure data and generate an authentication confirmation, and the memory controller is configured to grant the access to the user data based on the authentication confirmation.
Clause 10. The memory device of any of clauses 1-9, wherein: the secure data stored in the secure memory portion include a private key; the secure controller is configured to generate a signature based on the private key, generate a signed message based on the user data, and provide the signed message to a host device coupled to the memory device or to a data processor of the memory device.
Clause 11. The memory device of any of clauses 1-9, wherein: the secure data stored in the secure memory portion include a public key; the secure controller is configured to receive a signed message from a host device coupled to the memory device or from a data processor of the memory device, obtain the public key from the secure memory portion, verify the signature associated with the signed message using the public key, and extract content of the signed message in accordance with verification of the signature.
Clause 12. The memory device of any of clauses 1-11, wherein the integrated memory enclosure includes one or more tamper evidence labels configured to visually indicate whether a tamper attempt has occurred to the memory device.
Clause 13. The memory device of any of clauses 1-12, further comprising: a fastening structure for mechanically holding the integrated memory enclosure; a tamper detection circuit configured to generate tamper indication data indicating an occurrence of a tamper attempt in response to a mechanical unfastening force applied to the fastening structure.
Clause 14. The memory device of clause 13, wherein the secure controller is configured to: receive the tamper indication data directly from the tamper detection circuit; and in response to receiving the tamper indication data, select one of a plurality of tamper deterring actions, the plurality of tamper deterring actions including at least self destruction of the secure memory portion storing the secure data.
Clause 15. The memory device of any of clauses 1-14, wherein the memory device is coupled to a baseboard management controller (BMC), and the BMC is configured to access, via the secure controller, the secure data stored in the secure memory portion.
Clause 16. The memory device of any of clauses 1-15, wherein the secure data include an encrypted format of plaintext cryptographic security parameters (CSPs); and the secure controller is configured to operate on the plaintext CSPs.
Clause 17. The memory device of any of clauses 1-16, wherein the secure memory portion is accessible to the secure controller, and not accessible to the memory controller.
Clause 18. The memory device of any of clauses 1-17, wherein the secure controller is coupled to a host device via a data transport protocol, which includes a peripheral component interconnect express (PCIe) protocol and a nonvolatile memory express (NVMe) protocol.
Clause 19. The memory device of any of clauses 1-18, wherein the secure controller is configured to verify a first user account associated with a host device by: receiving, from the host device, a password associated with the first user account; receiving, from the host device, a signature provided by the first user account, wherein the signature is generated based on a private key and a challenge provided by the secure controller to the host device; verifying the password, the challenge, and the signature; and in accordance with a verification of both the password and the signature, providing the secure data to the host device.
Clause 20. A computer system, comprising: a plurality of memory devices, each memory device further including a memory device of any of clauses 1-19; wherein secure memory portions of the plurality of memory devices provide a distributed hardware security system.

Each of the above identified elements may be stored in one or more of the previously mentioned storage devices, and corresponds to a set of instructions for performing a function described above. The above identified modules or programs (i.e., sets of instructions) need not be implemented as separate software programs, procedures, modules or data structures, and thus various subsets of these modules may be combined or otherwise re-arranged in various embodiments. In some embodiments, the memory, optionally, stores a subset of the modules and data structures identified above. Furthermore, the memory, optionally, stores additional modules and data structures not described above.

The terminology used in the description of the various described implementations herein is for the purpose of describing particular implementations only and is not intended to be limiting. As used in the description of the various described implementations and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof. Additionally, it will be understood that, although the terms “first,” “second,” etc. may be used herein to describe various elements, these elements should not be limited by these terms. These terms are only used to distinguish one element from another.

As used herein, the term “if” is, optionally, construed to mean “when” or “upon” or “in response to determining” or “in response to detecting” or “in accordance with a determination that,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event]” or “in accordance with a determination that [a stated condition or event] is detected,” depending on the context.

The foregoing description, for purpose of explanation, has been described with reference to specific embodiments. However, the illustrative discussions above are not intended to be exhaustive or to limit the claims to the precise forms disclosed. Many modifications and variations are possible in view of the above teachings. The embodiments were chosen and described in order to best explain principles of operation and practical applications, to thereby enable others skilled in the art.

Although various drawings illustrate a number of logical stages in a particular order, stages that are not order dependent may be reordered and other stages may be combined or broken out. While some reordering or other groupings are specifically mentioned, others will be obvious to those of ordinary skill in the art, so the ordering and groupings presented herein are not an exhaustive list of alternatives. Moreover, it should be recognized that the stages can be implemented in hardware, firmware, software or any combination thereof.

What is claimed is:

1. A memory device, comprising:
a non-volatile memory including a secure memory portion and a data memory portion, wherein the secure memory portion stores secure data, and the data memory portion stores user data;
a memory controller coupled to the data memory portion, the memory controller configured to receive a data access request and access the user data in response to the data access request;
a secure controller coupled to the secure memory portion, the secure controller configured to access the secure data and implement a secure operation on the secure data; and
an integrated memory enclosure for enclosing the secure controller, the memory controller, and the non-volatile memory.

2. The memory device of claim 1, wherein the secure data is associated with the user data, and the user data is accessed based on a result of the secure operation on the secure data.

3. The memory device of claim 1, further comprising:
a volatile memory including a first memory portion and a second memory portion;
wherein the first memory portion is coupled to the secure controller and is accessible by the secure controller to store the secure data temporarily, and the second memory portion is coupled to the memory controller and accessible by the memory controller to store the user data temporarily in response to the data access request.

4. The memory device of claim 1, further comprising:
a data processor coupled to the non-volatile memory, the secure controller, and the memory controller, wherein the data processor is configured to exchange the user data with the memory controller and implement a data processing operation associated with the user data.

5. The memory device of claim 4, wherein the data processor is configured to implement the data processing operation associated with the user data based on a result of the secure operation implemented by the secure controller on the secure data.

6. The memory device of claim 1, wherein the secure data include one or more of: a cryptographic key, a digital certificate, authentication token or data, security policy, and audit log.

7. The memory device of claim 1, wherein the secure operation includes one or more of:
key generation, encryption, decryption, generation of a digital signature, key wrapping or unwrapping, key storage, key rotation, key destruction, cryptographic hashing, managing a message authentication code (MAC), managing a digital certificate, user authentication and authorization, secure boot, and recording a log.

8. The memory device of claim 1, wherein the secure operation includes one or more of:
establishing or managing one or more administrator credentials;
associating an administrator account with a set of cryptographic keys;
managing one or more administrator privileges for the administrator account(s);
establishing or enforcing one or more policies associated with tampering events for the administrator account(s);
controlling an access to user account(s);
managing cryptographic key(s) for a user account; and
enabling the administrator account to use the cryptographic key(s) for cryptographic operations.

9. The memory device of claim 1, wherein the secure controller is configured to authenticate a user account based on the secure data and generate an authentication confirmation, and the memory controller is configured to grant the access to the user data based on the authentication confirmation.

10. The memory device of claim 1, wherein:
the secure data stored in the secure memory portion include a private key;
the secure controller is configured to generate a signature based on the private key, generate a signed message based on the user data, and provide the signed message to a host device coupled to the memory device or to a data processor of the memory device.

11. The memory device of claim 1, wherein:
the secure data stored in the secure memory portion include a public key;
the secure controller is configured to receive a signed message from a host device coupled to the memory device or from a data processor of the memory device, obtain the public key from the secure memory portion, verify the signature associated with the signed message using the public key, and extract content of the signed message in accordance with verification of the signature.

12. The memory device of claim 1, wherein the integrated memory enclosure includes one or more tamper evidence labels configured to visually indicate whether a tamper attempt has occurred to the memory device.

13. The memory device of claim 1, further comprising:
a fastening structure for mechanically holding the integrated memory enclosure;
a tamper detection circuit configured to generate tamper indication data indicating an occurrence of a tamper attempt in response to a mechanical unfastening force applied to the fastening structure.

14. The memory device of claim 13, wherein the secure controller is configured to:
receive the tamper indication data directly from the tamper detection circuit; and
in response to receiving the tamper indication data, select one of a plurality of tamper deterring actions, the plurality of tamper deterring actions including at least self destruction of the secure memory portion storing the secure data.

15. The memory device of claim 1, wherein the memory device is coupled to a baseboard management controller (BMC), and the BMC is configured to apply the secure controller to access the secure data and implement the secure operation on the secure data.

16. The memory device of claim 1, wherein the secure data include an encrypted format of plaintext cryptographic security parameters (CSPs); and the secure controller is configured to operate on the plaintext CSPs.

17. The memory device of claim 1, wherein the secure memory portion is accessible to the secure controller, and not accessible to the memory controller.

18. The memory device of claim 1, wherein the secure controller is coupled to a host device via a data transport protocol, which includes a peripheral component interconnect express (PCIe) protocol and a nonvolatile memory express (NVMe) protocol.

19. The memory device of claim 1, wherein the secure controller is configured to verify a first user account associated with a host device by:
receiving, from the host device, a password associated with the first user account;
receiving, from the host device, a signature provided by the first user account, wherein the signature is generated based on a private key and a challenge provided by the secure controller to the host device;
verifying the password and the signature; and
in accordance with a verification of both the password and the signature, providing the secure data to the host device.

20. A computer system, comprising:
a plurality of memory devices, each memory device further including:
a non-volatile memory including a secure memory portion and a data memory portion, wherein the secure memory portion stores secure data, and the data memory portion stores user data;
a memory controller coupled to the data memory portion, the memory controller configured to receive a data access request and access the user data in response to the data access request;
a secure controller coupled to the secure memory portion, the secure controller configured to access the secure data and implement a secure operation on the secure data; and
an integrated memory enclosure for enclosing the secure controller, the memory controller, and the non-volatile memory;
wherein secure memory portions of the plurality of memory devices provide a distributed hardware security system.
